(19) United States
(12) Patent Application Publication
(10) Pub. No.: US 2013/0055229 A1
(43) Pub. Date: Feb. 28, 2013

(54) PROJECTION SYSTEM AND METHOD FOR UPDATING THE SAME

(71) Applicants: Chi-Wei Tung, Hsinchu (TW); Po-Yen Wu, Hsinchu (TW); Yi-Fa Wang, Hsinchu (TW); Chih-Lin Wang, Hsin-Chu (TW)

(72) Inventors: Chi-Wei Tung, Hsinchu (TW); Po-Yen Wu, Hsinchu (TW); Yi-Fa Wang, Hsinchu (TW); Chih-Lin Wang, Hsin-Chu (TW)

(73) Assignee: CORETRONIC CORPORATION, Hsin-Chu (TW)

(21) Appl. No.: 13/474,734

(22) Filed: May 18, 2012

(30) Foreign Application Priority Data
Aug. 31, 2011 (CN) 201110259866.0

(51) Int. Cl. G06F 9/44

(52) U.S. Cl. 717/168

(57) ABSTRACT

A projection system including a first projector and a plurality of second projectors is provided. The first projector has a control interface, a first transmission interface, a second transmission interface and a first image unit. The control interface is used for receiving an update message, and the first image unit performs firmware updating according to the update message. Each of the second projectors has a third transmission interface, a fourth transmission interface and a second image unit. The first transmission interface, the second transmission interface, the third transmission interfaces and the fourth transmission interfaces are connected in series to form a transmission channel. The first image unit transmits the update message to the second image units through the transmission channel, and the second image units perform firmware updating according to the update message.

### CROSS-REFERENCE TO RELATED APPLICATION

This application claims the priority benefit of China application Ser. No. 201110259866.0, filed on Aug. 31, 2011. The entirety of the above-mentioned patent application is hereby incorporated by reference herein and made a part of this specification.

### BACKGROUND OF THE INVENTION

1. Field of the Invention

The invention relates to a display system and a method for updating the same. Particularly, the invention relates to a projection system having a plurality of projectors and a method for updating the same.

2. Description of Related Art

A projector can project images on a larger screen to facilitate more people simultaneously watching contents of images displayed on the screen, so that it is generally applied in public occasions such as companies and schools, etc. Moreover, as domestic display products are developed towards a trend of large size, the projectors are gradually popularised in general families, and become commonly used electronic products in the modern life.

In the past, during firmware updating of the projector, the projector is required to activate a firmware updating mode through a special button or a button combination, and then the projector receives firmware updating data from a computer in a one-to-one manner, so that one computer only corresponds to one projector when firmware updating. When multiple projectors require the firmware updating, besides sequentially updating the projectors, the number of the computers can be increased to simultaneously providing the firmware updating data to multiple projectors.

On the other hand, when the computer is used to control the projector to display, the projector is generally equipped with a control interface for receiving commands from the computer. Generally, one control interface can only be used to couple one computer, so that the computer generally controls the projector to display in the one-to-one manner. According to the above description, when the computer is used to control multiple projectors to display, besides sequentially controlling the projectors, the number of the computers can be increased to simultaneously control multiple projectors.

Therefore, if the above firmware updating method and display control method are applied to a large amount of projectors for firmware updating and display controlling, longer time and more hardware cost are spent, and more human resource cost is required.

Taiwan Published Patent No. 200910202 discloses a multimedia access device, a multimedia playing system comprising the multimedia access device and a multimedia data playing method. The multimedia playing device is connected to a network through the multimedia access device, and receives a network data stream corresponding to a firmware updating file from a network server. Then, a processing circuit of the multimedia access device processes the network data stream into a universal serial bus (USB) data stream, and the multimedia playing device receives the firmware updating file to update the firmware therein.

Taiwan Published Patent No. 200527110 discloses a multimedia projection system, and firmware updating of the portable multimedia projection system can be implemented through network download or through files stored in a CD-ROM, a DVD or a flash memory card, etc. Preferably, the portable multimedia projection system can be directly connected an update server through the Internet.

### SUMMARY OF THE INVENTION

The invention is directed to a projection system and a method for updating the same, in which transmission interfaces of projectors are connected in series to form a transmission channel, and an update message and/or commands are transmitted to the projectors through the transmission channel, so as to synchronously update firmware of the projectors, and control a part of or all of the projectors to simultaneously project images. The above-mentioned firmware updating is an update operation performed to modify errors of a current operating system or add new functions in the current operating system.

Additional aspects and advantages of the invention will be set forth in the description of the techniques disclosed in the invention.

To achieve one of or all aforementioned and other advantages, an embodiment of the invention provides a projection system including a first projector and a plurality of second projectors. The first projector has a control interface, a first transmission interface, a second transmission interface and a first image unit. The first image unit is coupled to the control interface, and the first image unit, the first transmission interface and the second transmission interface are coupled to each other. The control interface is used for receiving an update message, and the first image unit performs firmware updating according to the update message. Each of the second projectors has a third transmission interface, a fourth transmission interface and a second image unit. In each of the second projectors, the third transmission interface, the fourth transmission interface and the second image unit are coupled to each other. The first transmission interface, the second transmission interface, the third transmission interfaces and the fourth transmission interfaces are connected in series to form a transmission channel. The first image unit transmits the update message to the second image unit through the transmission channel, and the second image units perform firmware updating according to the update message.

To achieve one of or all aforementioned and other advantages, an embodiment of the invention provides a method for updating a projection system. The projection system includes a first projector having a control interface, a first transmission interface, a second transmission interface and a first image unit, and a plurality of second projectors respectively having a third transmission interface, a fourth transmission interface and a second image unit. The first image unit is coupled to the control interface. The first image unit, the first transmission interface and the second transmission interface are coupled to each other. The third transmission interface, the fourth transmission interface and the second image unit of each of the third projectors are coupled to each other. The first transmission interface, the second transmission interface, the third transmission interfaces and the fourth transmission interfaces are connected in series to form a transmission channel. The method for updating the projection system includes following steps. A firmware updating command is transmitted to the first image unit through the control interface, so as to make the first image unit to enter a firmware updating mode. After the first image unit enters the firmware updating mode, firmware updating data is transmitted to the first image unit through the control interface, so as to make the first image unit to perform firmware updating according to the firmware updating data. The first image unit transmits the firmware updating command to the second image units through the transmission channel, so as to make the second image units to enter the firmware updating mode.

After the second image units enter the firmware updating mode, the first image unit transmits the firmware updating data to the second image units through the transmission channel, so as to make the second image units to perform firmware updating according to the firmware updating data.

According to the above descriptions, in the projection system and the method for updating the same, the first transmission interface and the second transmission interface of the first projector and the third transmission interface and the fourth transmission interface of each of the second projectors are connected in series to form a transmission channel. After the first projector enters a synchronous updating mode, the first image unit transmits the update message to the second image units through the transmission channel to synchronously implement the firmware updating of the second image units. In this way, time and hardware cost required in firmware updating of a large amount of projectors are reduced.

Other objectives, features and advantages of the invention will be further understood from the further technological features disclosed by the embodiments of the invention wherein there are shown and described preferred embodiments of the invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an operational schematic diagram illustrating firmware updating of projectors of a projection system according to an embodiment of the invention.

FIG. 1B is an operational schematic diagram illustrating image projection control of all projectors of a projection system according to an embodiment of the invention.

FIG. 1C is an operational schematic diagram illustrating image projection control of a part of projectors of a projection system according to an embodiment of the invention.

FIG. 1D is a flowchart illustrating a method for updating a projection system according to an embodiment of the invention.

FIG. 2A is an operational schematic diagram illustrating firmware updating of projectors of a projection system according to another embodiment of the invention.

FIG. 2B is an operational schematic diagram illustrating image projection control of all projectors of a projection system according to another embodiment of the invention.

FIG. 2C is an operational schematic diagram illustrating image projection control of a part of projectors of a projection system according to another embodiment of the invention.

FIG. 2D is a flowchart illustrating a method for updating a projection system according to another embodiment of the invention.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

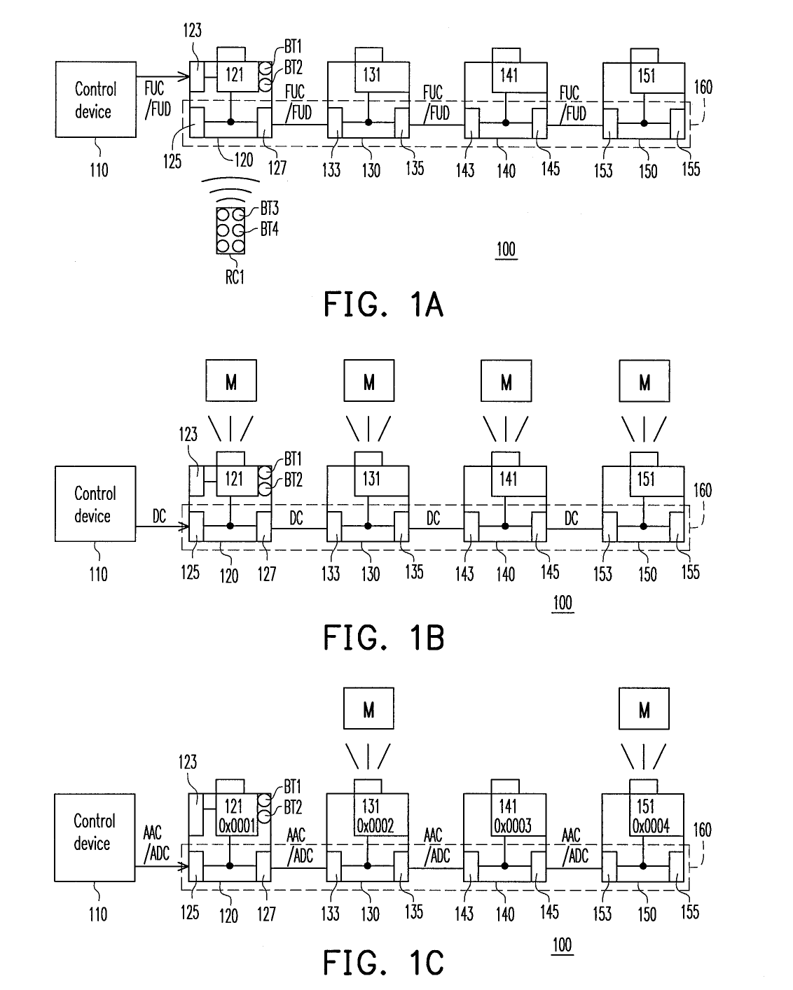

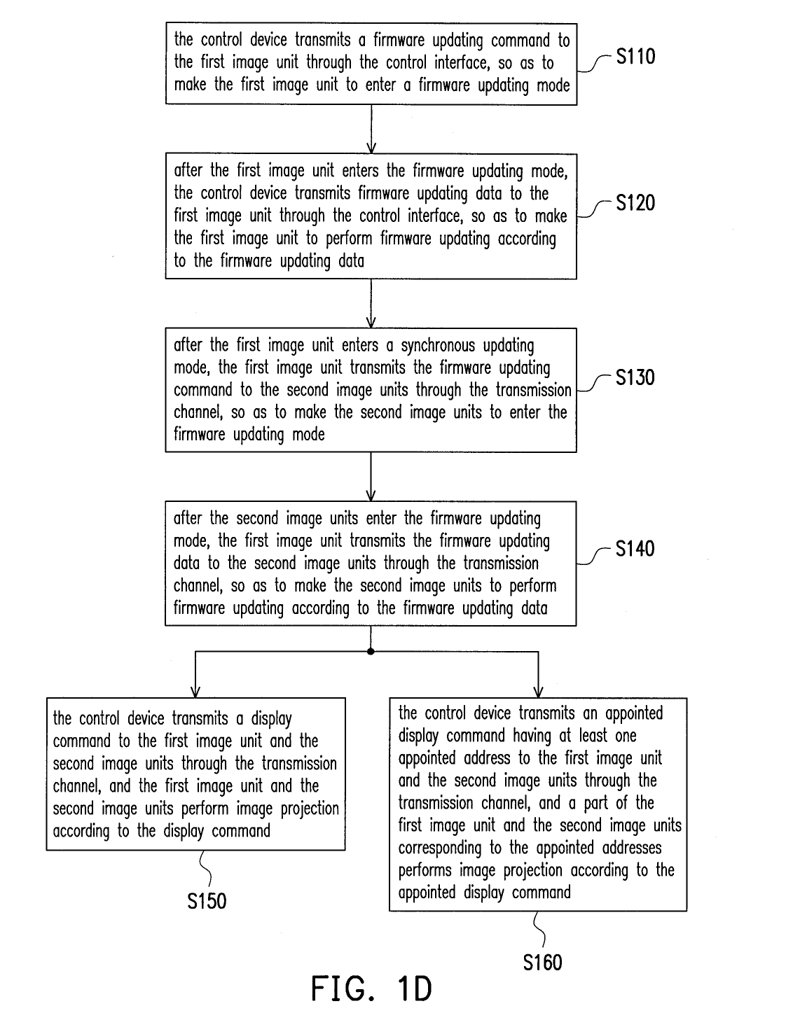

FIG. 1A is an operational schematic diagram illustrating firmware updating of projectors of a projection system according to an embodiment of the invention. Referring to FIG. 1A, in the present embodiment, the projection system 100 includes a control device 110, and projectors 120, 130, 140 and 150, where the control device 110 can be a computer or a similar device. The projector 120 (corresponding to a first projector) has an image unit 121 (corresponding to a first image unit), a control interface 123, transmission interfaces 125 (corresponding to a first transmission interface) and 127 (corresponding to a second transmission interface), wherein the image unit 121 is coupled to the control interface 123, and the image unit 121, the transmission interfaces 125 and 127 are coupled to each other. In an embodiment of the invention, the control interface 123 is, for example, a network interface, a universal serial buss (USB) interface, a RS232 interface or a similar transmission interface.

The projector 130 (corresponding to a second projector) has an image unit 131 (corresponding to a second image unit) and transmission interfaces 133 (corresponding to a third transmission interface) and 135 (corresponding to a fourth transmission interface), wherein the image unit 131 and the transmission interfaces 133 and 135 are coupled to each other. The projector 140 (corresponding to the second projector) has an image unit 141 (corresponding to the second image unit) and transmission interfaces 143 (corresponding to the third transmission interface) and 145 (corresponding to the fourth transmission interface), wherein the image unit 141 and the transmission interfaces 143 and 145 are coupled to each other. The projector 150 (corresponding to the second projector) has an image unit 151 (corresponding to the second image unit) and transmission interfaces 153 (corresponding to the third transmission interface) and 155 (corresponding to the fourth transmission interface), wherein the image unit 151 and the transmission interfaces 153 and 155 are coupled to each other.

In the present embodiment, the transmission interfaces 125, 127, 133, 135, 143, 145, 153 and 155 are sequentially connected in series to form a transmission channel 160, wherein the transmission interfaces 125, 127, 133, 135, 143, 145, 153 and 155 can be transmission interfaces including inter-integrated circuit (12C) interfaces, for example, digital visual interfaces (DVI), video graphics array (VGA) interfaces, or high-definition multimedia interfaces.

The projector 120 receives an update message (i.e. a firmware updating command FUC and firmware updating data FUD) from the control device 110 through the control interface 123. When the image unit 121 of the projector 120 receives the firmware updating command FUC, it controls the projector 120 to enter a firmware updating mode, and replies the control device 110 that the firmware updating mode is entered. Then, the control device 110 outputs the firmware updating data FUD to the control interface 123, and the image unit 121 performs firmware updating according to the received firmware updating data FUD, and replies the control device 110 after the firmware updating is completed. Then, the image unit 121 controls the projector 120 to switch to a normal mode.

Moreover, when the control device 110 does not receive a reply from the image unit 121 within a predetermined time (for example, 1 second) after transmitting the firmware updating command FUC, the control device 110 again transmits the firmware updating command FUC to the image unit 121. When the number of times for transmitting the firmware updating command FUC reaches a predetermined number of times (for example, 5 times), the control device 110 prompts an error message to notify a user that the projector 120 is failed to receive the firmware updating command FUC. When the image unit 121 successfully receives the firmware updating command FUC, the control device 110 starts to transmit the firmware updating data FUD, and if the control device 110 does not receive a reply from the image unit 121 within another predetermined time (for example, 10 seconds), the control device 110 again transmits the firmware updating data FUD to the image unit 121. When the number of times for transmitting the firmware updating data FUD reaches another predetermined number of times (for example, 3 times), the control device 110 prompts an error message to notify the user that firmware updating of the projector 120 is failed.

Generally, the projector 120 or a corresponding remote controller (for example, a remote controller RC1) is equipped with buttons (for example, buttons BT1-BT4) to facilitate operation of the projector 120. In the present embodiment, when a specific button (for example, one of the buttons BT1-BT4) or a specific button combination is pressed, the image unit 121 controls the projector 120 to enter a synchronous updating mode. Now, the image unit 121 transmits the firmware updating command FUC to the image units 131, 141 and 151 through the transmission channel 160, and the projectors 130, 140 and 150 enter the firmware updating mode.

After the projectors 130, 140 and 150 enter the firmware updating mode, the image units 131, 141 and 151 reply the image unit 121 that the firmware updating mode is entered. Then, the image unit 121 transmits the firmware updating data FUD to the image units 131, 141 and 151 through the transmission channel 160, and the image units 131, 141 and 151 perform firmware updating according to the received firmware updating data FUD, and reply the image unit 121 after the firmware updating is completed. After the firmware updating of the image units 131, 141 and 151 are all completed, the image unit 121 controls the projector 120 to switch to the normal mode. The image units 131, 141 and 151 respectively control the projectors 130, 140 and 150 to switch to the normal mode after replying the image unit 121 that the firmware updating is completed.

According to the above descriptions, when the specific button (for example, one of the buttons BT1-BT4) or the specific button combination is pressed, the image unit 121 controls the projector 120 to enter the synchronous updating mode, and the image unit 121 of the projector 120 transmits the firmware updating command FUC and the firmware updating data FUD to the image units 131, 141 and 151 through the transmission channel 160. In this way, time and hardware cost required in firmware updating of a large amount of projectors are reduced.

Moreover, when the image unit 121 does not receive replies from the image units 131, 141 and 151 within a predetermined time (for example, 1 second) after transmitting the firmware updating command FUC, the image unit 121 again transmits the firmware updating command FUC to the image units 131, 141 and 151. When the number of times for transmitting the firmware updating command FUC reaches a predetermined number of times (for example, 5 times), the image unit 121 prompts an error message to notify the user that the projectors 130, 140 and 150 are failed to receive the firmware updating command FUC. When the image units 131, 141 and 151 successfully receive the firmware updating command FUC, the image unit 121 starts to transmit the firmware updating data FUD, and if the image unit 121 does not receive replies from the image units 131, 141 and 151 within another predetermined time (for example, 10 seconds), the image unit 121 again transmits the firmware updating data FUD to the image units 131, 141 and 151. When the number of times for transmitting the firmware updating data FUD reaches another predetermined number of times (for example, 3 times), the image unit 121 prompts an error message to notify the user that firmware updating of the projectors 130, 140 and 150 is failed.

In some embodiments of the invention, when the image unit 121 receives a reply from at least one of the image units 131, 141 and 151, the image unit 121 still transmits the firmware updating data FUD to the projector entering the firmware updating mode. Regarding the image unit that does not reply for entering the firmware updating mode or the firmware updating thereof is completed, the projector thereof is regarded to be failed in firmware updating.

FIG. 1B is an operational schematic diagram illustrating image projection control of all projectors of a projection system according to an embodiment of the invention. Referring to FIG. 1A and FIG. 1B, the same reference numbers refer to the same or like parts, and descriptions thereof are not repeated. In the present embodiment, the control device 110 outputs a display command DC to the transmission channel 160, wherein the display command DC does not specify a command-executing image unit (for example, the image units 121, 131, 141 and 151), i.e. the display command DC is a commonly executed command. The display command DC is transmitted to the image units 121, 131, 141 and 151 through the transmission channel 160, and the image units 121, 131, 141 and 151 respectively project an image M according to the display command DC. According to the above descriptions, the control device 110 can transmit commands to the image units 121, 131, 141 and 151 through the transmission channel 160, and control the projectors 120, 130, 140 and 150 without increasing hardware cost, so as to test the projectors 120, 130, 140 and 150.

FIG. 1C is an operational schematic diagram illustrating image projection control of a part of projectors of a projection system according to an embodiment of the invention. Referring to FIG. 1 A and FIG. 1 C, the same reference numbers refer to the same or like parts, and descriptions thereof are not repeated. In the present embodiment, corresponding addresses of the image units 121, 131, 141 and 151 are respectively set as 0×0001, 0×0002, 0×0003 and 0×0004. The corresponding addresses of the image units 121, 131, 141 and 151 can be automatically assigned or set by the user through an operation interface (for example, the buttons BT1-BT4).

When the corresponding addresses of the image units 121, 131, 141 and 151 are automatically assigned, the control device 110 outputs an addressing command AAC to the transmission channel 160, wherein the addressing command AAC, for example, includes a start address (for example, 0×0001). When the image unit 121 receives the addressing command AAC from the control device 110, the image unit 121 sets an address thereof as 0×0001, and adds the address by 1 (i.e. 0×0002) and transmits the addressing command AAC to a next projector. When the image unit 131 receives the addressing command AAC from the image unit 121, the image unit 131 sets an address thereof as 0×0002, and adds the address by 1 (i.e. 0×0003) and transmits the addressing command AAC to a next projector. Deduced by analogy, the image units 141 and 151 sequentially set addresses thereof as 0×0003 and 0×0004. Therefore, the image units 121, 131, 141 and 151 sequentially set the addresses thereof as 0×0001, 0×0002, 0×0003 and 0×0004 according to the addressing command AAC.

In the present embodiment, the control device 110 outputs an appointed display command ADC having at least one appointed address (for example, addresses 0×0002 and 0×0004) to the transmission channel 160, wherein the appointed addresses are addresses corresponding to the image units appointed to execute the command (which are, for example, image units 131 and 151 in the present embodiment). The appointed display command ADC is transmitted to the image units 121, 131, 141 and 151 through the transmission channel 160. Since the image units 131 and 151 are appointed to execute the command, the image units 131 and 151 project the image M according to the appointed display command ADC, and the image units 121 and 141 neglect the appointed display command ADC. According to the above descriptions, the control device 110 can transmit commands to the image units 121, 131, 141 and 151 through the transmission channel 160, and control a part of the projectors 120, 130, 140 and 150 without increasing the hardware cost, so as to test a part of the projectors 120, 130, 140 and 150.

FIG. 1D is a flowchart illustrating a method for updating a projection system according to an embodiment of the invention. Referring to FIG. 1D, in the present embodiment, the projection system includes a control device, a first projector having a control interface, a first transmission interface, a second transmission interface and a first image unit, and a plurality of second projectors respectively having a third transmission interface, a fourth transmission interface and a second image unit. The first transmission interface, the second transmission interface, the third transmission interfaces and the fourth transmission interfaces are coupled in series to form a transmission channel.

First, the control device transmits a firmware updating command to the first image unit through the control interface, so as to make the first image unit to enter a firmware updating mode (step S110). After the first image unit enters the firmware updating mode, the control device transmits firmware updating data to the first image unit through the control interface, so as to make the first image unit to perform firmware updating according to the firmware updating data (step S120). After the first image unit enters a synchronous updating mode, the first image unit transmits the firmware updating command to the second image units through the transmission channel, so as to make the second image units to enter the firmware updating mode (step S130). After the second image units enter the firmware updating mode, the first image unit transmits the firmware updating data to the second image units through the transmission channel, so as to make the second image units to perform firmware updating according to the firmware updating data (step S140).

On the other hand, the control device transmits a display command to the first image unit and the second image units through the transmission channel, and the first image unit and the second image units perform image projection according to the display command (step S150). Alternatively, the control device transmits an appointed display command having at least one appointed address to the first image unit and the second image units through the transmission channel, and a part of the first image unit and the second image units corresponding to the appointed addresses perform image projection according to the appointed display command (step S160). The aforementioned sequence of the above steps is only used as an example, and the invention is not limited thereto. Moreover, details of the above steps can refer to related descriptions of the embodiments of FIG. 1A to FIG. 1C, which are not repeated herein.

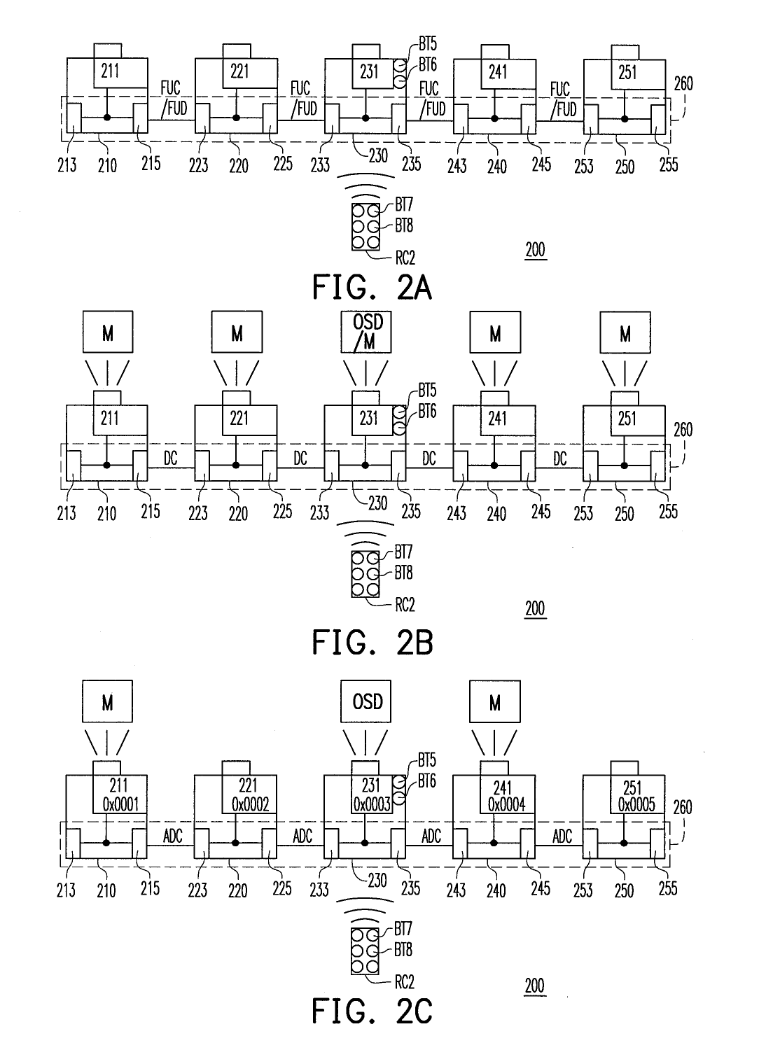

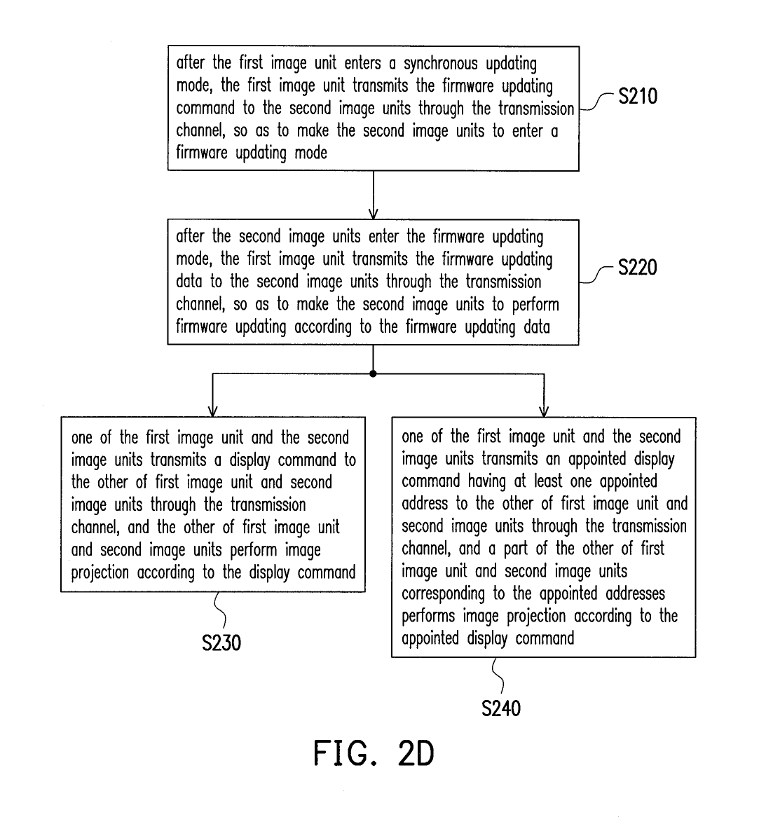

FIG. 2A is an operational schematic diagram illustrating firmware updating of projectors of a projection system according to another embodiment of the invention.

Referring to FIG. 2A, in the present embodiment, the projection system 200 includes projectors 210, 220, 230, 240 and 250. In the present embodiment, it is assumed that the projector 230 is a firmware-updated projector (corresponding to the first projector), i.e. an image unit 231 (corresponding to the first image unit) of the projector 230 has completed firmware updating according to the update message (i.e. the firmware updating command FUC and the firmware updating data FUD). The firmware updating can refer to related descriptions of FIG. 1A, which is not repeated herein.

The projector 210 has an image unit 211 (corresponding to the second image unit) and transmission interfaces 213 (corresponding to the third transmission interface) and 215 (corresponding to the fourth transmission interface), wherein the image unit 211 and the transmission interfaces 213 and 215 are coupled to each other. The projector 220 (corresponding to the second projector) has an image unit 221 (corresponding to the second image unit) and transmission interfaces 223 (corresponding to the third transmission interface) and 225 (corresponding to the fourth transmission interface), wherein the image unit 221 and the transmission interfaces 223 and 225 are coupled to each other. The projector 230 has an image unit 231 and transmission interfaces 233 (corresponding to the first transmission interface) and 235 (corresponding to the second transmission interface), wherein the image unit 231 and the transmission interfaces 233 and 235 are coupled to each other. The projector 240 (corresponding to the second projector) has an image unit 241 (corresponding to the second image unit) and transmission interfaces 243 (corresponding to the third transmission interface) and 245 (corresponding to the fourth transmission interface), wherein the image unit 241 and the transmission interfaces 243 and 245 are coupled to each other. The projector 250 (corresponding to the second projector) has an image unit 251 (corresponding to the second image unit) and transmission interfaces 253 (corresponding to the third transmission interface) and 245 (corresponding to the fourth transmission interface), wherein the image unit 251 and the transmission interfaces 253 and 255 are coupled to each other.

In the present embodiment, the transmission interfaces 213, 215, 223, 225, 233, 235, 243, 245, 253 and 255 are connected in series to form a transmission channel 260, wherein the transmission interfaces 213, 215, 223, 225, 233, 235, 243, 245, 253 and 255 can be transmission interfaces including inter-integrated circuit (I2C) interfaces, for example, digital visual interfaces (DVI), video graphics array (VGA) interfaces, or high-definition multimedia interfaces.

When a specific button (for example, one of buttons BT5-BT8) or a specific button combination on the projector 230 or a corresponding remote controller (for example, RC2) thereof is pressed, the image unit 231 controls the projector 230 to enter the synchronous updating mode. Now, the image unit 231 transmits the firmware updating command FUC to the transmission channel 260 through the transmission interfaces 233 and 235, so as to transmit the firmware updating command FUC to the image units 211, 221, 241 and 251 through the transmission channel 260. When the image units 211, 221, 241 and 251 receives the firmware updating command FUC, the image units 211, 221, 241 and 251 respectively control the projectors 210, 220, 240 and 250 to enter the firmware updating mode.

After the projectors 210, 220, 240 and 250 enter the firmware updating mode, the image units 211, 221, 241 and 251 reply the image unit 231 that the firmware updating mode is entered. Then, the image unit 231 transmits the firmware updating data FUD to the image units 211, 221, 241 and 251 through the transmission channel 260, and the image units 211, 221, 241 and 251 perform firmware updating according to the received firmware updating data FUD, and reply the image unit 231 after the firmware updating is completed. After the firmware updating of the image units 211, 221, 241 and 251 are all completed, the image unit 231 controls the projector 230 to switch to the normal mode. The image units 211, 221, 241 and 251 respectively control the projectors 210, 220, 240 and 250 to switch to the normal mode after replying the image unit 231.

According to the above descriptions, when the specific button (for example, one of the buttons BT5-BT8) or the specific button combination is pressed, the image unit 231 controls the projector 230 to enter the synchronous updating mode, and the image unit 231 of the projector 230 transmits the firmware updating command FUC and the firmware updating data FUD to the image units 211, 221, 241 and 251 through the transmission channel 260. In this way, time and hardware cost required in firmware updating of a large amount of projectors are reduced.

Moreover, when the image unit 231 does not receive replies from the image units 211, 221, 241 and 251 within a predetermined time (for example, 1 second) after transmitting the firmware updating command FUC, the image unit 231 again transmits the firmware updating command FUC to the image units 211, 221, 241 and 251. When the number of times for transmitting the firmware updating command FUC reaches a predetermined number of times (for example, 5 times), the image unit 231 prompts an error message to notify the user that the projectors 210, 220, 240 and 250 are failed to receive the firmware updating command FUC. When the image units 211, 221, 241 and 251 successfully receive the firmware updating command FUC, the image unit 231 starts to transmit the firmware updating data FUD, and if the image unit 231 does not receive replies from the image units 211, 221, 241 and 251 within another predetermined time (for example, 10 seconds), the image unit 231 again transmits the firmware updating data FUD to the image units 211, 221, 241 and 251. When the number of times for transmitting the firmware updating data FUD reaches another predetermined number of times (for example, 3 times), the image unit 231 prompts an error message to notify the user that firmware updating of the projectors 210, 220, 240 and 250 is failed.

In some embodiments of the invention, when the image unit 231 receives a reply from at least one of the image units 211, 221, 241 and 251, the image unit 231 still transmits the firmware updating data FUD to the projector entering the firmware updating mode. Regarding the image unit that does not reply for entering the firmware updating mode or the firmware updating thereof is completed, the projector thereof is regarded to be failed in firmware updating.

FIG. 2B is an operational schematic diagram illustrating image projection control of all projectors of a projection system according to another embodiment of the invention. Referring to FIG. 2A and FIG. 2B, the same reference numbers refer to the same or like parts, and descriptions thereof are not repeated. In the present embodiment, when the user operates the projector 230 through buttons (for example, the buttons BT5-BT6), the image unit 231 projects a menu image OSD for the user to operate. When the user controls the projectors 210, 220, 240 and 250 through the menu image OSD, the image unit 230 outputs a display command DC to the transmission channel 260, wherein the display command DC does not specify a command-executing image unit (for example, the image units 211, 221, 231, 241 and 251), i.e. the display command DC is a commonly executed command.

The display command DC is transmitted to the image units 211, 221, 241 and 251 through the transmission channel 260, and the image units 211, 221, 231, 241 and 251 respectively project an image M according to the display command DC. According to the above descriptions, the image unit 231 can transmit commands to the image units 211, 221, 241 and 251 through the transmission channel 260, and control the projectors 210, 220, 240 and 250 through the projector 230 without increasing hardware cost, so as to test the projectors 210, 220, 240 and 250.

In the present embodiment, the user operates the projectors 210, 220, 240 and 250 through the projector 230, though in other embodiments, the user can use one of the projectors 210, 220, 240 and 250 to operate the other projectors (210, 220, 230, 240 and 250), which is not limited by the invention.

FIG. 2C is an operational schematic diagram illustrating image projection control of a part of projectors of a projection system according to another embodiment of the invention. Referring to FIG. 2A and FIG. 2C, the same reference numbers refer to the same or like parts, and descriptions thereof are not repeated. When the user operates the projector 230 through the buttons (for example, the buttons BT5-BT6), the image unit 231 projects the menu image OSD for the user to operate. In the present embodiment, corresponding addresses of the image units 211, 221, 231, 241 and 251 are respectively set as 0×0001, 0×0002, 0×0003, 0×0004 and 0×0005, wherein the corresponding addresses of the image units 211, 221, 231, 241 and 251 can be automatically assigned or set by the user through an operation interface (for example, the buttons BT5-BT8), and descriptions of the automatic assignment can refer to the related descriptions of FIG. 1C, which are not repeated herein.

In the present embodiment, when the user operates a part of the projectors 210, 220, 240 and 250 through the menu image OSD, the user can select an address (i.e. appointed address) corresponding to at least one of the projectors to be operated through the menu image OSD, and the image unit 231 outputs an appointed display command ADC having the above appointed address to the transmission channel 260.

Assuming the projectors to be operated are the projectors 210 and 240, the appointed display command ADC transmitted by the image unit 231 includes addresses 0×0001 and 0×0004. The appointed display command ADC is transmitted to the image units 211, 221, 231, 241 and 251 through the transmission channel 260. Since the projectors 210 and 240 are to be operated (i.e. the image units 211 and 241 are appointed to execute the appointed display command ADC), the image units 211 and 241 project the image M according to the appointed display command ADC, and the image units 221 and 251 neglect the appointed display command ADC. According to the above descriptions, the image unit 231 can transmit commands to the image units 211, 221, 231, 241 and 251 through the transmission channel 260, and control a part of the projectors 210, 220, 240 and 250 without increasing the hardware cost, so as to test a part of the projectors 210, 220, 240 and 250.

In the present embodiment, the user operates the projectors 210, 220, 240 and 250 through the projector 230, though in other embodiments, the user can use one of the projectors 210, 220, 240 and 250 to operate a part of the other projectors (210, 220, 230, 240 and 250), which is not limited by the invention.

FIG. 2D is a flowchart illustrating a method for updating a projection system according to another embodiment of the invention. Referring to FIG. 2D, in the present embodiment, the projection system includes a first projector having a first transmission interface, a second transmission interface and a first image unit, and a plurality of second projectors respectively having a third transmission interface, a fourth transmission interface and a second image unit. The first transmission interface, the second transmission interface, the third transmission interfaces and the fourth transmission interfaces are coupled in series to form a transmission channel, and the first image unit has completed the firmware updating.

In the present embodiment, after the first image unit enters the synchronous updating mode, the first image unit transmits the firmware updating command to the second image units through the transmission channel, so as to make the second image units to enter the firmware updating mode (step S210). After the second image units enter the firmware updating mode, the first image unit transmits the firmware updating data to the second image units through the transmission channel, so as to make the second image units to perform firmware updating according to the firmware updating data (step S220).

On the other hand, one of the first image unit and the second image units transmits a display command to the other of first image unit and second image units through the transmission channel, and the other of first image unit and second image units perform image projection according to the display command (step S230). Alternatively, one of the first image unit and the second image units transmits an appointed display command having at least one appointed address to the other of first image unit and second image units through the transmission channel, and a part of the other of first image unit and second image units corresponding to the appointed addresses performs image projection according to the appointed display command (step S240). The aforementioned sequence of the above steps is only used as an example, and the invention is not limited thereto. Moreover, details of the above steps can refer to related descriptions of the embodiments of FIG. 2A to FIG. 2C, which are not repeated herein.

In summary, in the projection system and the method for updating the same, the first transmission interface and the second transmission interface of the first projector and the third transmission interfaces and the fourth transmission interfaces of the second projectors are connected in series to form a transmission channel. After the first projector enters the synchronous updating mode, the first image unit transmits the update message to the second image units through the transmission channel to synchronously implement the firmware updating of the second image units. Moreover, one of the control device, the first image unit of the first projector and the second image units of the second projectors can transmit the display command or the appointed display command through the transmission channel. In this way, time and hardware cost required in firmware updating and/or operation of a large amount of projectors are reduced.

In addition, “first”, “second”, “third”, and “fourth” in the first projector, the first image unit, the second projector, the second image unit, the first transmission interface, the second transmission interface, the third transmission interface and the fourth transmission interface, etc., described in the invention only represent the names of the elements, and are not used to limit the amount of the elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection system, comprising:
a first projector, comprising a control interface, a first transmission interface, a second transmission interface and a first image unit, wherein the first image unit is coupled to the control interface, and the first image unit, the first transmission interface and the second transmission interface are coupled to each other, the control interface is used for receiving an update message, and the first image unit performs firmware updating according to the update message; and
a plurality of second projectors, respectively comprising a third transmission interface, a fourth transmission interface and a second image unit, and in each of the second projectors, the third transmission interface, the fourth transmission interface and the second image unit coupled to each other, wherein the first transmission interface, the second transmission interface, the third transmission interfaces and the fourth transmission interfaces are connected in series to form a transmission channel,
wherein the update message is transmitted from the first image unit to the second image units through the transmission channel, and the second image units performs firmware updating according to the update message.

2. The projection system as claimed in claim 1, further comprising a control device for providing the update message.

3. The projection system as claimed in claim 2, wherein the control device outputs an addressing command to the transmission channel, and the first image unit and the second image units are sequentially set to a plurality of addresses according to the addressing command.

4. The projection system as claimed in claim 2, wherein the control device outputs an appointed display command comprising at least one appointed address to the transmission channel, and a part of the first image unit and the second image units corresponding to the at least one appointed address performs image projection according to the appointed display command.

5. The projection system as claimed in claim 2, wherein the control device outputs a display command to the transmission channel, and the first image unit and the second image units perform image projection according to the display command.

6. The projection system as claimed in claim 1, wherein one of the first image unit and the second image units outputs a display command to the transmission channel, and the other of first image unit and second image units performs image projection according to the display command.

7. The projection system as claimed in claim 1, wherein one of the first image unit and the second image units outputs an appointed display command comprising at least one appointed address to the transmission channel, and a part of the other of first image unit the second image units corresponding to the at least one appointed address performs image projection according to the appointed display command.

8. The projection system as claimed in claim 1, wherein the update message comprises a firmware updating command and firmware updating data, wherein the firmware updating command is used for controlling the first image unit and the second image units to enter a firmware updating mode, and making the first image unit and the second image units to perform the firmware updating according to the firmware updating data.

9. The projection system as claimed in claim 1, wherein the control interface is one of a network interface, a universal serial bus interface and a RS232 interface.

10. The projection system as claimed in claim 1, wherein the first transmission interface, the second transmission interface, the third transmission interfaces and the fourth transmission interfaces respectively comprise an inter-integrated circuit (I2C) interface.

11. A method for updating a projection system, wherein the projection system comprises a first projector having a control interface, a first transmission interface, a second transmission interface and a first image unit, and a plurality of second projectors respectively comprising a third transmission interface, a fourth transmission interface and a second image unit, the first image unit is coupled to the control interface, the first image unit, the first transmission interface and the second transmission interface are coupled to each other, the third transmission interface, the fourth transmission interface and the second image unit of each of the third projectors are coupled to each other, and the first transmission interface, the second transmission interface, the third transmission interfaces and the fourth transmission interfaces are connected in series to form a transmission channel, the method for updating the projection system comprising:
transmitting a firmware updating command to the first image unit through the control interface, so as to make the first image unit to enter a firmware updating mode;
transmitting firmware updating data to the first image unit through the control interface after the first image unit enters the firmware updating mode, so as to make the first image unit to perform firmware updating according to the firmware updating data;
transmitting the firmware updating command by the first image unit to the second image units through the transmission channel, so as to make the second image units to enter the firmware updating mode; and
transmitting the firmware updating data by the first image unit to the second image units through the transmission channel after the second image units enter the firmware updating mode, so as to make the second image units to perform firmware updating according to the firmware updating data.

12. The method for updating the projection system as claimed in claim 11, wherein the firmware updating command and the firmware updating data are provided by a control device.

13. The method for updating the projection system as claimed in claim 12, further comprising:
the control device transmitting an addressing command to the first image unit and the second image units through the transmission channel, so as to sequentially set the first image unit and the second image units to a plurality of addresses according to the addressing command.

14. The method for updating the projection system as claimed in claim 12, further comprising:
the control device transmitting an appointed display command having at least one appointed address to the first image unit and the second image units through the transmission channel, so that a part of the first image unit and the second image units corresponding to the at least one appointed address performs image projection according to the appointed display command.

15. The method for updating the projection system as claimed in claim 12, further comprising:
the control device transmitting a display command to the first image unit and the second image units through the transmission channel, so that the first image unit and the second image units perform image projection according to the display command.

16. The method for updating the projection system as claimed in claim 11, further comprising:
one of the first image unit and the second image units outputting a display command to the other of first image unit and second image units through the transmission channel, so that the other of first image unit and second image units performs image projection according to the display command.

17. The method for updating the projection system as claimed in claim 11, further comprising:
one of the first image unit and the second image units outputting an appointed display command having at least one appointed address to the other of first image unit and second image units through the transmission channel, so that a part of the other of first image unit and second image units corresponding to the at least one appointed address performs image projection according to the appointed display command.

18. A projection system, comprising:
a first projector, having a control interface, a first transmission interface, a second transmission interface and a first image unit, wherein the first image unit is coupled to the control interface, and the first image unit, the first transmission interface and the second transmission interface are coupled to each other, the control interface is used for receiving an update message, and the first image unit performs firmware updating according to the update message; and
a second projector, having a third transmission interface, a fourth transmission interface and a second image unit, wherein the third transmission interface, the fourth transmission interface and the second image unit are coupled to each other, and the second image unit performs firmware updating according to the update message,
wherein the first transmission interface, the second transmission interface, the third transmission interface and the fourth transmission interface are connected in series to form a transmission channel.
